(19) United States
(12) Patent Application Publication
(10) Pub. No.: US 2016/0186614 A1
(43) Pub. Date: Jun. 30, 2016

(54) TURBINE EXHAUST CASE ASSEMBLY

(71) Applicant: United Technologies Corporation, Hartford, CT (US)

(72) Inventor: Jose R. Paulino, Saco, ME (US)

(21) Appl. No.: 14/826,292

(22) Filed: Aug. 14, 2015

Related U.S. Application Data
(60) Provisional application No. 62/042,304, filed on Aug. 27, 2014.

(51) Int. Cl. F01D 25/30

(52) U.S. Cl. CPC F01D 25/30; F05D 2220/32; F05D 2230/60; F05D 2240/24

(57) ABSTRACT

A turbine exhaust case assembly includes a frame which includes an outer ring, an inner ring, a plurality of struts that connect the inner ring and the outer ring and a monolithic fairing assembly that surrounds the frame.

### CROSS-REFERENCE TO RELATED APPLICATIONS

This application claims priority to U.S. Provisional Application No. 62/042,304, which was filed on Aug. 27, 2014 and is incorporated herein by reference.

### BACKGROUND

Turbine exhaust cases typically comprise structural frames that support the very aft end of a gas turbine engine. In aircraft applications, the turbine exhaust case can be utilized to mount the engine to the aircraft airframe. In industrial gas turbine applications, the turbine exhaust case can be utilized to couple the gas turbine engine to an electrical generator.

A typical turbine exhaust case comprises an outer ring coupled to an outer diameter case of a low pressure turbine, an inner ring that surrounds the engine centerline, and frame struts connecting the inner ring to the outer ring. As such, the turbine exhaust is typically subject to various types of loading, thereby requiring the turbine exhaust case to be structurally strong and rigid. Due to the placement of the turbine exhaust case within the hot gas stream exhausted from the turbines of the gas turbine engine, it is typically desirable to shield the turbine exhaust case structural frame with a fairing that is able to withstand direct impingement of the hot gas stream. The fairing includes hollow struts that surround the frame struts. The structural frame and the fairing can each be optimized for their respective functions, such as load bearing and temperature capabilities.

Conventionally, manufacturing the turbine exhaust case involved casting the frame as a single piece and separately welding segments of the fairing around the frame. However, replacement of the frame would require the fairing to be disassembled which would harm the structural and aerodynamic integrity of the fairing. However, separating the frame into pieces inherently produces structural weaknesses that may degrade performance of the frame. Therefore, there is a need for an improved turbine exhaust case assembly and method of manufacturing.

### SUMMARY

In one exemplary embodiment, a turbine exhaust case assembly includes a frame which includes an outer ring, an inner ring, a plurality of struts that connect the inner ring and the outer ring and a monolithic fairing assembly that surrounds the frame.

In a further embodiment of the above, the inner ring and the outer ring are made of a first material and the plurality of struts is made of a second different material.

In a further embodiment of any of the above, each of the plurality of struts is held equally in tension.

In a further embodiment of any of the above, at least one of the plurality of struts includes at least one pin that extends through an opening in the outer ring.

In a further embodiment of any of the above, the frame includes at least one radial passage defined by the outer ring, the inner ring and at least one of the plurality of struts.

In a further embodiment of any of the above, the radially extending passage includes a strut passage aligned with an inner ring passage and an outer ring passage.

In a further embodiment of any of the above, a line drilled opening extends through each of the plurality of struts and the outer ring.

In a further embodiment of any of the above, a shear pin extends through the line drilled opening.

In another exemplary embodiment, a gas turbine engine section includes a turbine section and a turbine exhaust case assembly including a frame which includes an outer ring, an inner ring, a plurality of struts that connect the inner ring and the outer ring and a monolithic fairing assembly that surround the frame.

In a further embodiment of the above, the frame includes at least one radial passage defined by the outer ring, the inner ring, and at least one of the plurality of struts.

In a further embodiment of any of the above, the radially extending passage includes a strut passage aligned with an inner ring passage and an outer ring passage.

In a further embodiment of any of the above, a line drilled opening extends through each of the plurality of struts and the outer ring.

In a further embodiment of any of the above, each of the plurality of struts is held equally in tension.

In another exemplary embodiment, a method of assembling a turbine exhaust case assembly includes locating a plurality of struts through an opening in an outer ring, attaching an inner ring to a radially inner end of each of the plurality of struts, applying an equal tensile force to each of the plurality of struts and attaching each of the plurality of struts to the outer ring while applying the tensile force.

In a further embodiment of any of the above, the method includes line drilling a fastener opening through the outer ring and at least one of the plurality of struts while the tensile force is being applied to each of the plurality of struts.

In a further embodiment of any of the above, the method includes locating a shear pin in the fastener opening.

In a further embodiment of any of the above, the tensile force is applied to each of the plurality of struts through at least one pin that extends from each of the plurality of struts through the outer ring.

In a further embodiment of any of the above, the method includes locating a fairing assembly between the outer ring and the inner ring.

In a further embodiment of any of the above, a strut passage is aligned with an inner ring passage and an outer ring passage to form a radially extending passage.

These and other features of the disclosed examples can be understood from the following description and the accompanying drawings, which can be briefly described as follows.

### BRIEF DESCRIPTION OF THE DRAWINGS

FIG. 1 is a schematic view of an example gas turbine engine.

FIG. 2 shows an example industrial gas turbine engine with a generator.

FIG. 3 shows an example turbine exhaust case frame.

FIG. 4 shows a cross-section view taken along line 4-4 of FIG. 3.

FIG. 5 shows an example outer ring with an example liner.

FIG. 6 shows the example outer ring and liner with an example inner ring and strut.

FIG. 7 shows the example inner ring attached to the example strut of FIG. 6.

FIG. 8 shows the example strut attached to the example inner ring and the example outer ring of FIG. 6.

### DETAILED DESCRIPTION

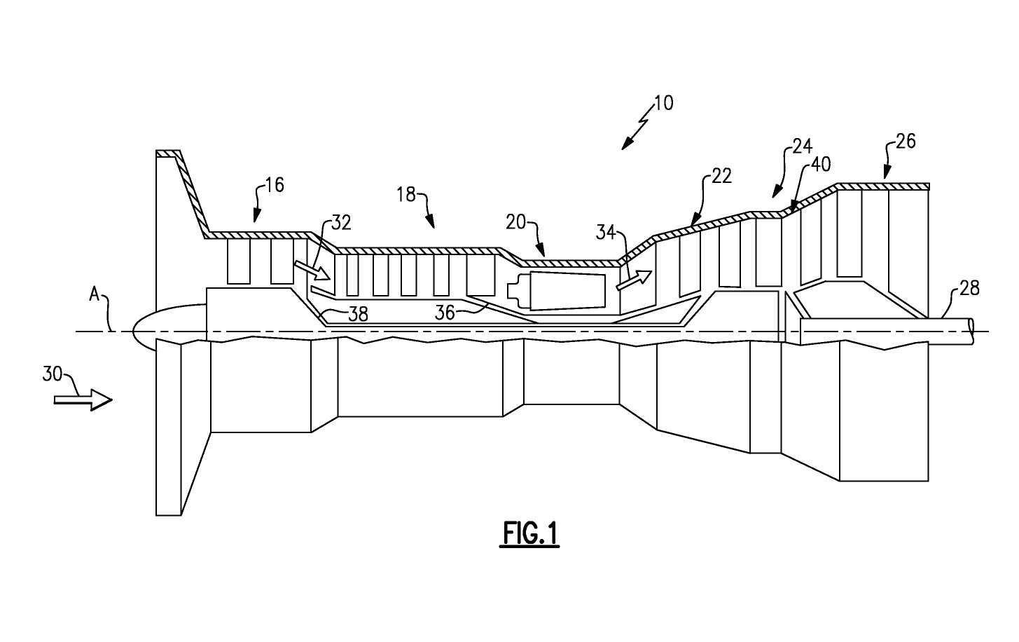

FIG. 1 illustrates a schematic view of a gas turbine engine 10. In the illustrated example, the gas turbine engine 10 is an industrial gas turbine engine circumferentially disposed about a central, longitudinal engine axis A. In this disclosure, radial or radial direction is relative to the engine axis A unless otherwise specified.

The gas turbine engine 10 includes, in series order from an axial front to an axial rear, a low pressure compressor section 16, a high pressure compressor section 18, a combustor section 20, a high pressure turbine section 22, and a low pressure turbine section 24. In the illustrated embodiment, a power turbine section 26 is a free turbine section disposed aft of the low pressure turbine 24 and drives a power turbine drive shaft 28 (FIG. 2).

Incoming ambient air 30 entering the gas turbine engine 10 becomes pressurized air 32 in the low pressure compressor 16 and the high pressure compressor 18. Fuel mixes with the pressurized air 32 in the combustor section 20 prior to ignition and combustion of the fuel. Once the fuel has combusted, combustion gases 34 expand through the high pressure turbine section 22, the low pressure turbine section 24, and through the power turbine section 26. The high and low pressure turbine sections 22 and 24 drive high and low pressure rotor shafts 36 and 38, respectively, which rotate in response to the combustion products and thus rotate the attached high and low pressure compressor sections 18 and 16. The power turbine section 26 may, for example, drive an electrical generator 54, pump, or gearbox through the power turbine drive shaft 28 (FIG. 2).

A low pressure turbine exhaust case 40 is positioned between the low pressure turbine section 24 and the power turbine section 26. The turbine exhaust case 40 defines a flow path for gas exhausted from low pressure turbine section 24 that is conveyed to power turbine 26. The turbine exhaust case 40 also provides structural support for the gas turbine engine 10.

A basic understanding and overview of the various sections and the basic operation of the gas turbine engine 10 is provided in FIG. 1. However, this disclosure is applicable to all types of gas turbine engines, including those with aerospace applications and industrial applications. Similarly, although the disclosure is described with reference to the low pressure turbine exhaust case 40, the disclosure is applicable to other components of the gas turbine engine 10, such as intermediate exhaust cases, and mid-turbine frames.

As shown in FIG. 2, an example industrial gas turbine engine assembly 50 including a gas turbine engine 52, such as the example gas turbine engine 10 described above, is mounted to a structural land based frame to drive the electrical generator 54.

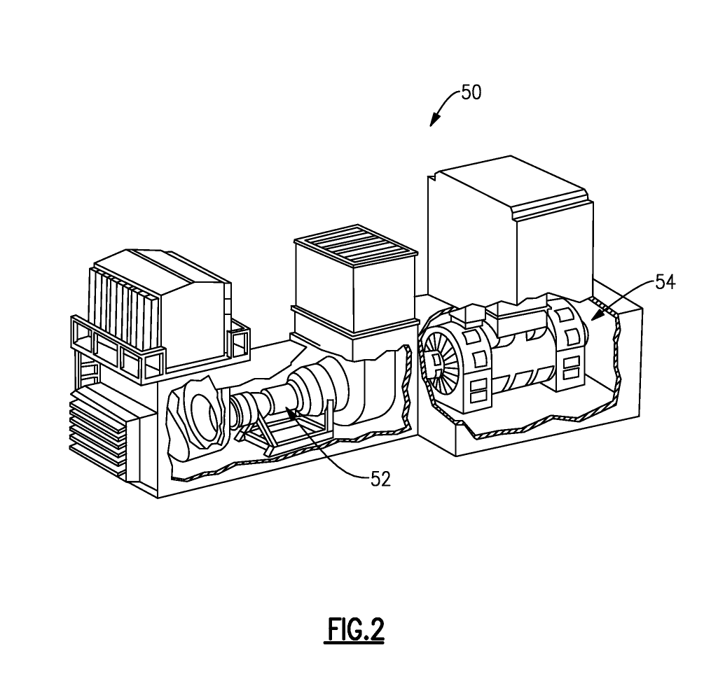

FIGS. 3 and 4 illustrate an example exhaust case frame 60 including an outer ring 62, an inner ring 64, and struts 66 extending between the outer ring 62 and the inner ring 64 that connect the outer ring 62 to the inner ring 64. The outer ring 62 includes a generally conical shape with an upstream end having a smaller diameter than a downstream end, while the inner ring 64 has a generally cylindrical shape. However, other shapes could be used for the inner ring 64 and the outer ring 66.

The inner ring 64 includes multiple pairs of flanges 68 that are circumferentially spaced around a radially outer side of the inner ring 64 for engaging the struts 66. Fasteners 70 extend through flange openings 72 in the pair of flanges 68 and strut openings 74 in the strut 66. In the illustrated example, the fasteners 70 are shear pins or another type of fastener capable of carrying a load in shear.

The outer ring 62 includes protrusions 76 circumferentially spaced around a radially outer side forming strut recesses 78 (FIG. 4) on a radially inner side for receiving a radially outer end of the strut 66. The fasteners 70 secure the strut 66 to the outer ring 62 by extending through protrusion openings 80 in the protrusions 76 and the strut openings 74 in the strut 66.

Radially outer ends of the struts 66 include pins 82 that extend radially outward through pin openings 84 the outer ring 62. The pins 82 are cylindrical and may include threads. The pins 82 can be formed integrally with the strut 66 or may be attached by some other method, such as welding to the strut 66.

In the illustrated example, the inner ring 64 and the outer ring 62 are made from an alloy steel and the struts 66 are made of a high strength nickel alloy, such as Inconel 718 or waspaloy.

As shown in FIG. 4, the case frame 60 includes a radial passage 79 formed by an outer ring passage 81, a strut passage 83, and an inner ring passage 85. The outer ring passage 81 extends through a radially outer side of the protrusion 76 adjacent the strut 66. The strut passage 83 extends between opposing radial ends of the strut 66 and is aligned with the outer ring passage 81. The inner ring passage 85 extends between a radially inner side and a radially outer side of the inner ring 64 and is aligned with the strut passage 83. The radial passage 79 allows cooling oil or cooling air to pass between the radially outer side of the case frame 60 and the radially inner side of the case frame 60.

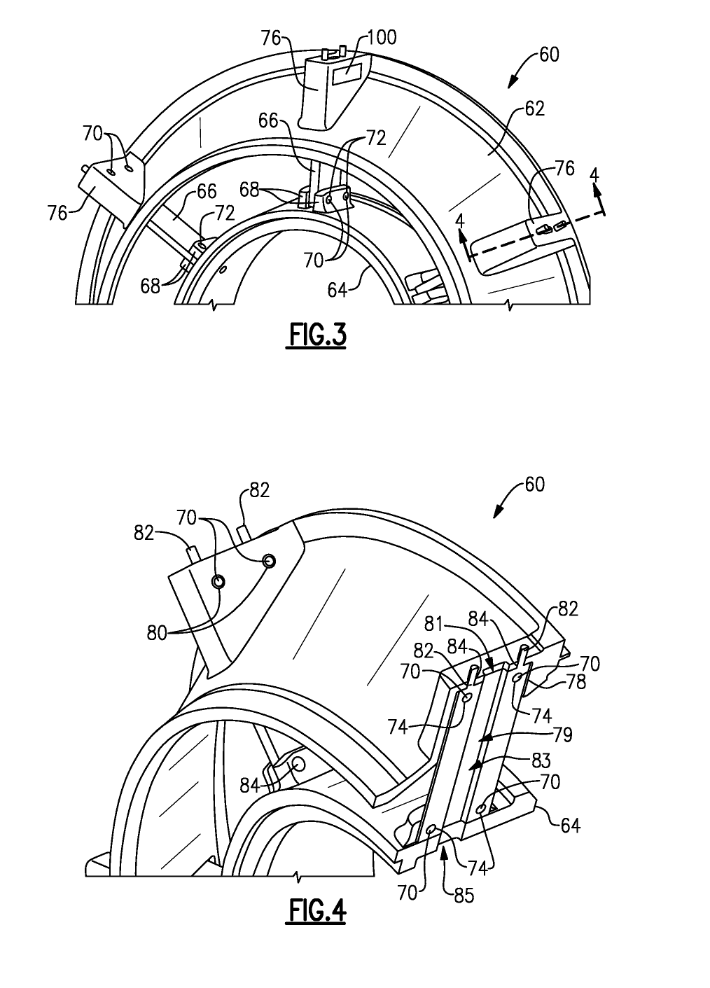

As shown in FIG. 5, the exhaust gas case 40 is assembled by bringing a monolithic nickel alloy liner 90 or fairing assembly into axial and circumferential alignment with the outer ring 62 such that strut openings 92 in the liner 90 are aligned with the strut recesses 78 in the outer ring 62. The liner 90 includes fairings 94 that surround and define the strut openings 92 and connect a radially inner portion 96 with a radially outer portion 98 of the liner 90 to form a flow path for the combustion gases 34. In the illustrated example, the liner 90 is cast from a nickel alloy so that it is a monolithic structure without seams connecting adjacent circumferential sections of the liner 90 that would require welding or another form of attachment.

Once the liner 90 has been aligned with the outer ring 62, the strut 66 is placed within the strut opening 92 and the strut recess 78 by placing the strut 66 on the radially inner side of the liner 90 and moving the strut 66 in the radially outward direction (FIG. 6). When the strut 66 is placed within the strut recess 78 and the pins 82 are aligned with the pin openings 84, the pins 82 extend radially outward beyond a radially outer side of the protrusion 76 of the outer ring 62.

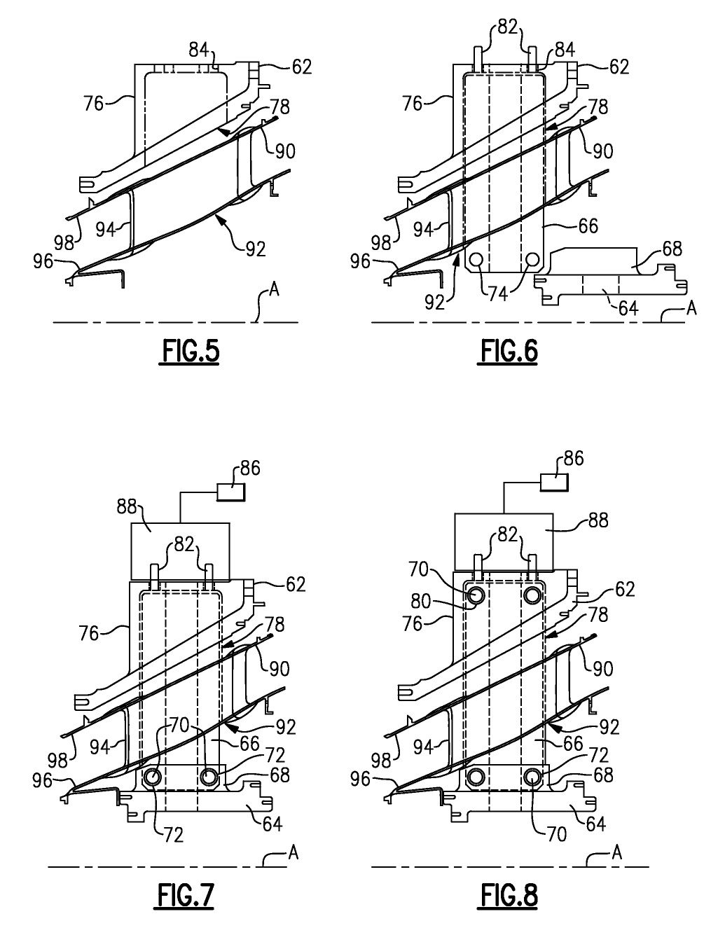

As shown in FIGS. 6 and 7, the inner ring 64 is moved axially forward or upstream until the pair of flanges 68 are aligned with the strut 66. Once the pair of flanges 68 is aligned with the strut 66, the flange openings 72 in the pair of flanges 68 align with the strut openings 74 in the strut 66. Fasteners 70 are then placed through the flange openings 72 and the strut openings 74 to secure the strut 66 to the inner ring 64.

Alternatively, the strut 66 and the pair of flanges 68 may not include the strut openings 74 and the flange openings 72, respectively. In this case, the strut openings 74 and the flange openings 72 are formed by a single line drilling process to ensure that the flange openings 72 align with the strut openings 74. The fasteners 70 are then placed through the flange openings 72 and the strut openings 74 after line drilling to secure the strut 66 to the inner ring 64.

FIG. 7 shows a hydraulic pump 86 in fluid communication with a tensioner 88. The tensioner 88 is securely attached to the pins 82 and presses against a radially outer side of the protrusions 76 to place the struts 66 attached to the inner ring 64 in tension. Although only a single tensioner 88 in communication with the hydraulic pump 86 is shown, additional tensioners 88 can attach similarly to the pins 82 on each of the struts 66 spaced around the circumference of the outer ring 62 so that uniform tension is applied to all of the struts 66 of the case frame 60.

While the strut 66 is held in tension by the tensioner 88, the protrusion openings 80 and the strut openings 74 are formed by a line drilling process so that the protrusion openings 80 align with strut openings 74 to accept the fasteners 70. Once the fasteners 70 have been installed to secure the struts 66 to the outer ring 62, the tensioner 88 can be removed. Because the fasteners 70 are experiencing a shear force resulting from the struts 66 being preloaded in tension, the fasteners 70 will be retained relative to the inner ring 64, the outer ring 62 and the strut 66 by the preload. However, a cover plate 100 (FIG. 3) may be placed over opposite ends of the fasteners 70 against either the pair of flanges 68 or the protrusions 76 to further retain the fasteners 70.

Because the turbine exhaust case 40 is assembled with fasteners 70 instead of welding or casting as a single unit, the exhaust case 40 can be disassembled without destroying the exhaust case frame 60 or the liner 90. Therefore, if only a portion of the turbine exhaust case 40 is damaged, the turbine exhaust case 40 can be disassembled to replace or repair the damaged portion.

The turbine exhaust case 40 is disassembled by attaching the tensioner 88 to the pins 82 and applying a tensile force that releases the pressure on the fasteners 70. Once the tension on the fasteners 70 has been removed, the fasteners 70 that hold the strut 66 relative to the outer ring 62 can be removed and then the fasteners 70 that hold the strut 66 to the inner ring 64 can be removed. Then the inner ring 64 can be removed axially relative to the outer ring 62. The struts 66 can then be removed followed by the liner 90. Any portion of the turbine exhaust case 40 that is damaged can then be repaired or replaced. The exhaust case 40 can then be reassembled in the same manner as described above.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A turbine exhaust case assembly comprising:
a frame including:
an outer ring;
an inner ring; and
a plurality of struts connecting the inner ring and the outer ring; and
a monolithic fairing assembly surrounding the frame.

2. The assembly of claim 1, wherein the inner ring and the outer ring are made of a first material and the plurality of struts is made of a second different material.

3. The assembly of claim 1, wherein each of the plurality of struts is held equally in tension.

4. The assembly of claim 1, wherein the at least one of the plurality of struts includes at least one pin that extends through an opening in the outer ring.

5. The assembly of claim 1, wherein the frame includes at least one radial passage defined by the outer ring, the inner ring, and at least one of the plurality of struts.

6. The assembly of claim 5, wherein the radially extending passage includes a strut passage aligned with an inner ring passage and an outer ring passage.

7. The assembly of claim 1, further comprising a line drilled opening extending through each of the plurality of struts and the outer ring.

8. The assembly of claim 7, further comprising a shear pin extending through the line drilled opening.

9. A gas turbine engine section comprising:
turbine section; and
a turbine exhaust case assembly including:
a frame including:
an outer ring;
an inner ring; and
a plurality of struts connecting the inner ring and the outer ring;
a monolithic fairing assembly surrounding the frame.

10. The gas turbine engine section of claim 9, wherein the frame includes at least one radial passage defined by the outer ring, the inner ring, and at least one of the plurality of struts.

11. The gas turbine engine section of claim 10, wherein the radially extending passage includes a strut passage aligned with an inner ring passage and an outer ring passage.

12. The gas turbine engine section of claim 9, further comprising a line drilled opening extending through each of the plurality of struts and the outer ring.

13. The gas turbine engine section of claim 9, wherein each of the plurality of struts is held equally in tension.

14. A method of assembling a turbine exhaust case assembly comprising:
locating a plurality of struts through an opening in an outer ring;
attaching an inner ring to a radially inner end of each of the plurality of struts;
applying an equal tensile force to each of the plurality of struts; and
attaching each of the plurality of struts to the outer ring while applying the tensile force.

15. The method of claim 14, further comprising line drilling a fastener opening through the outer ring and at least one of the plurality of struts while the tensile force is being applied to each of the plurality of struts.

16. The method of claim 15, further comprising locating a shear pin in the fastener opening.

17. The method of claim 14, wherein the tensile force is applied to each of the plurality of struts through at least one pin extending from each of the plurality of struts through the outer ring.

18. The method of claim 14, further comprising locating a fairing assembly between the outer ring and the inner ring.

19. The method of claim 14, further comprising a strut passage aligned with an inner ring passage and an outer ring passage to form a radially extending passage.
